(19) United States
(12) Patent Application Publication
(10) Pub. No.: US 2024/0337253 A1
(43) Pub. Date: Oct. 10, 2024

(54) DUCTED FLUID TURBINE WITH DYNAMIC AMPLIFICATION CONTROL

(71) Applicant: Vincent Loccisano, Wellesley, MA (US)

(72) Inventor: Vincent Loccisano, Wellesley, MA (US)

(21) Appl. No.: 18/628,957

(22) Filed: Apr. 8, 2024

Related U.S. Application Data
(60) Provisional application No. 63/494,938, filed on Apr. 7, 2023.

(51) Int. Cl. F03D 80/80; F03D 7/02

(52) U.S. Cl. CPC F03D 80/88; F03D 7/0296

(57) ABSTRACT

A fluid-turbine system with a rotor assembly in fluid communication with a duct assembly with a center of pressure offset from the center of yaw rotation; and having a resilient coupling between stationary and rotating members of a yaw system for the purpose of mitigating stress, on yaw system components, due to dynamic amplification loads particularly from off axis gusts.

### TECHNICAL FIELD

The present disclosure relates to fluid-turbine systems, and more particularly to fluid-turbine systems having a rotor assembly in fluid communication with a duct assembly with a center of pressure offset from the center of yaw rotation. A resilient coupling between stationary and rotating members of a yaw system mitigates stress due to dynamic amplification loads and particularly from off-axis gusts.

### BACKGROUND

Conventional horizontal-axis fluid turbines have two to five open blades arranged like a propeller. The blades are mounted to a horizontal shaft that is attached to a gear box, which drives a power generator.

Ducted or diffusor-augmented wind turbines are known in the art to increase the amount of energy a wind-turbine rotor can extract from a fluid stream. In a diffusor-augmented turbine, the upstream flow-capture area of the fluid stream is larger than the area at the rotor plane. At the rotor plane by the duct, the fluid stream is contracted and accelerates, and in the diffusor portion of the duct, the fluid stream expands and decelerates downstream after leaving the duct. The amount of energy that may be harvested from the fluid is proportional to the upstream flow-capture area, where the fluid stream starts in a non-contracted state. In a conventional diffuser-augmented turbine, the diffuser surrounds the rotor such that the diffuser guides incoming fluid before it interacts with the rotor, providing the greatest unit-mass flow rate substantially proximal to the rotor plane.

Turbines are typically mounted on vertical support structures at the turbine's approximate center of gravity, near the center of pressure. The center of pressure is the point on the turbine where the sum of the pressure field causes a force but no moment-force about that point. A turbine's center of pressure is typically near the downwind portion of the rotor plane. A support structure is often located behind the rotor plane at the nacelle.

A yaw system rotates a turbine about the turbine's vertical axis. It typically comprises a yaw bearing, drive and brake. The bearing and drive serve to rotate the turbine into the direction of the fluid stream. A yaw brake is commonly employed to eliminate backlash between gear-rim and yaw-drive pinions and to prevent the nacelle from oscillations caused by the rotation of the rotor, and to prevent extraneous movement from yaw error or from off-axis gusts.

Wind turbines are often located in areas having relatively predictable wind patterns, which vary between 15-25 m/s. In storm conditions, wind speeds can reach levels capable of damaging wind-turbine structures. Turbines are constructed and reinforced to withstand the effects of high wind speeds, but excessive wind conditions and high-speed gusts can cause significant fatigue loads on the structural components of a wind turbine. Ducted turbines have additional structural surface area, resulting in additional fatigue loads and stress on structural components.

Flow over the duct surface that separates or stalls is called “bluff-body” flow. “Time-resolved loads” are those measured or predicted as a function of time. “Time-averaged loads” are time-resolved loads averaged over a period of time.

A combination of increased surface area and bluff-body flow results in significantly increased time-averaged loads and time-resolved loads. “Dynamic amplification factor” is the ratio of peak time-resolved loads to time-averaged loads. High dynamic amplification factors are the combination of 1) Low or negative acro-damping and 2) Coherent vortex-shedding phenomena associated with bluff-bodies results.

Aeroelastic response of a structure is defined as the effect of loads on turbine structure. There are three primary mechanisms involved in aeroelastic response: buffeting, vortex-shedding and aeroelastic instability. Buffeting is defined as loads from incoming turbulence loading a structure. Vortex-shedding is the alternate shedding of quasi-coherent vortices that detach periodically from alternate sides of a body, generating an oscillatory load. Vortex-shedding is particularly damaging when shedding frequencies are coincident with the natural frequency of support structures. Aeroelastic instability, also known as flutter, occurs when motion-dependent aerodynamic forces reinforce motion of the structure in a manner sufficient to overcome the structural damping of the system. In other words, flutter occurs when aerodynamic forces on an object couple with a structure's natural mode of vibration to produce rapid periodic motion.

A normal mode of an oscillating system is a pattern of motion in which components or subsystems move with identical frequencies and with a fixed phase relation. Frequencies of normal modes of a system are referred to as natural frequencies or resonant frequencies. The normal modes of a ducted turbine are a part of a turbine's aeroelastic response.

Normal modes experienced by ducted turbine include a fore and aft normal mode, and lateral normal mode. Factors contributing to the fore and aft normal mode are related to drag caused by the mass of the duct and the rotor in the fluid stream. Factors contributing to the lateral normal mode are off-axis winds and yaw error. The behavior of each variable influences that of the others. This leads to a coupling of the oscillations within the individual degrees of freedom of each of the normal modes in the system.

Resilient couplings are common and include a number of mechanical devices that transfer torque and rotation between shafts by a flexible means. In one example, a beam coupling transmits torque between two shafts while allowing for angular misalignment, parallel offset and even axial motion of one shaft relative to another. A beam coupling is a single piece of material that becomes flexible by removal of material, typically along a spiral path. Other resilient couplings include two components joined by a polymer, such as a cast urethane, with each of the components engaging with one of the coupled shaft members.

A viscous coupling is a mechanical device which transfers torque and rotation through a viscous fluid that has sheer-thickening properties. Two sets of arrayed plates alternately engaged with each of the shafts to be coupled will rotate freely when the two sets are rotating in unison. When the plates rotate at differing speeds, the sheer effect of the fluid causes it to become nearly solid, effectively adhering the two sets of plates together and transferring torque from one to the other.

The present invention discloses a method to design a diffusor-augmented turbine with significantly reduced dynamic amplification factors by employing a resilient coupling about the yaw axis for the purpose of decoupling oscillations in the turbine system.

### SUMMARY

A fluid-turbine system provides an improved means of mitigating dynamic amplification by decoupling the interaction between at least two normal modes in the system. These and other opportunities for improvement are addressed and or overcome by the assemblies, systems and methods of the present disclosure.

An improved fluid-turbine system has a rotor assembly that is in fluid communication with a duct assembly, and in certain embodiments, with ducted turbines that are annular surfaces of substantially uniform thickness. In other embodiments, shroud assemblies of the present disclosure take the form of ringed airfoils (substantially circular in form). The shroud assemblies of the present disclosure may take a variety of forms including duct assemblies or airfoils having a non-circular shape; assemblies or airfoils that include gaps of sections along their circumference, periphery or shape; etc.

An airfoil assembly (e.g., ringed airfoil assembly) that surrounds or is disposed about a rotor assembly is typically known as a turbine-shroud assembly. The turbine-shroud assembly may be generally cylindrical or faceted, and is configured to generate relatively lower pressure within the turbine-shroud assembly (the interior of the shroud) and relatively higher pressure outside the turbine shroud (the exterior of the shroud). The shroud assembly/ringed airfoil may be cambered, with an airfoil cross-section.

In some embodiments, a second shroud assembly may be located proximal or adjacent to the trailing edge of the turbine-shroud assembly. This second shroud assembly is referred to as an ejector-shroud assembly. It may be the shape of a ringed or faceted airfoil, with the ring having an airfoil cross-section.

Shrouded and/or ducted fluid turbines more efficiently generate electrical energy from fluid currents, but they require increased surface area, which results in increased loading on the structural components of the shrouded fluid turbine.

In one embodiment, a shrouded fluid turbine is engaged with a support structure near the turbine's center of gravity, and pivots on the support structure on an axis that is offset from the center of pressure.

When the turbine is properly yawed into a fluid stream, an off-axis gust causes lateral motion of the turbine, displacing the turbine shaft along a horizontal plane. An off-axis gust also causes a rotation on the yaw axis. This rotation is a result of the embodiment's center of rotation being offset from the turbine's center of pressure.

Fore and aft displacement of the turbine system may be caused by the inherent flexibility of the cantilevered tower, combined with the offset of the turbine's center of mass from the yaw axis. This, plus changes in wind velocity, plus the effect of rotor motion, can cause periodic displacement of the turbine in a fore and aft direction. Fore and aft oscillations in a phase relationship with lateral oscillations result in the dynamic amplification of coupled oscillations.

A resilient coupling engaged with the yaw axis between the pinion gear and yaw motor, or between the pinion gear and the ring gear of the turbine system, provides a damping means to arrest lateral oscillations. Damping lateral oscillations mitigates the dynamic amplification of the coupled oscillations.

### BRIEF DESCRIPTION OF THE DRAWINGS

FIG. 1 is a front-perspective view of an embodiment of a fluid-turbine system;

FIG. 2 is front-perspective, section view of the yaw system of the turbine of FIG. 1;

FIG. 3 is a side, section, detail view of the yaw system of the turbine of FIG. 1.

### DETAILED DESCRIPTION

Although specific terms are used in the following description, these terms are intended to refer only to particular structures in the drawings and are not intended to limit the scope of the present disclosure. It is to be understood that like numeric designations refer to components of like function.

In certain embodiments, a ducted turbine or a mixer-ejector fluid turbine provides an improved means of generating power from fluid currents. A turbine shroud assembly may be disposed about a rotor assembly, with the rotor assembly extracting power from a primary fluid stream. A mixer-ejector pump may be included in some embodiments to ingest flow from the primary fluid stream and secondary flow, and promotes turbulent mixing of the two fluid streams. These systems increase the amount of fluid flow through the system, increasing the velocity at the rotor assembly for more power availability. It is an object of the present invention to control the amount of fluid flow through the system.

Used herein, “rotor assembly” may refer to any assembly in which blades are attached to a shaft and rotate, allowing for the generation of power or energy from fluid rotating the blades. Any type of rotor assembly may be used with the fluid turbines of the present disclosure.

The leading edge of a turbine shroud may be considered the front, and the trailing edge of an ejector shroud may be considered the rear of the fluid turbine. A first component of the fluid turbine, located closer to the front of the turbine, may be considered “upstream” of a second “downstream” component closer to the rear of the turbine.

The present disclosure is an improved fluid-turbine system with a rotor assembly in fluid communication with a duct assembly or an annular airfoil assembly (referred to as a turbine-shroud assembly), having boundary layer flow-control devices including plasma actuators or pulsed-plasma actuators.

In certain embodiments, a fluid-turbine system has a shroud assembly surrounding a rotor assembly. In some embodiments, an ejector-shroud assembly surrounds the exit of the turbine-shroud assembly. The fluid-turbine system of the present disclosure may or may not include an ejector-shroud assembly.

“Resilient coupling” describes a range of assemblies or devices for transferring torque and rotation through a flexible medium. One skilled in the art recognizes various suitable devices practical to the present disclosure. The recited embodiments of the figures are not intended to be limiting in scope.

Drawing figures are not necessarily to scale and in certain views, parts may have been exaggerated for clarity.

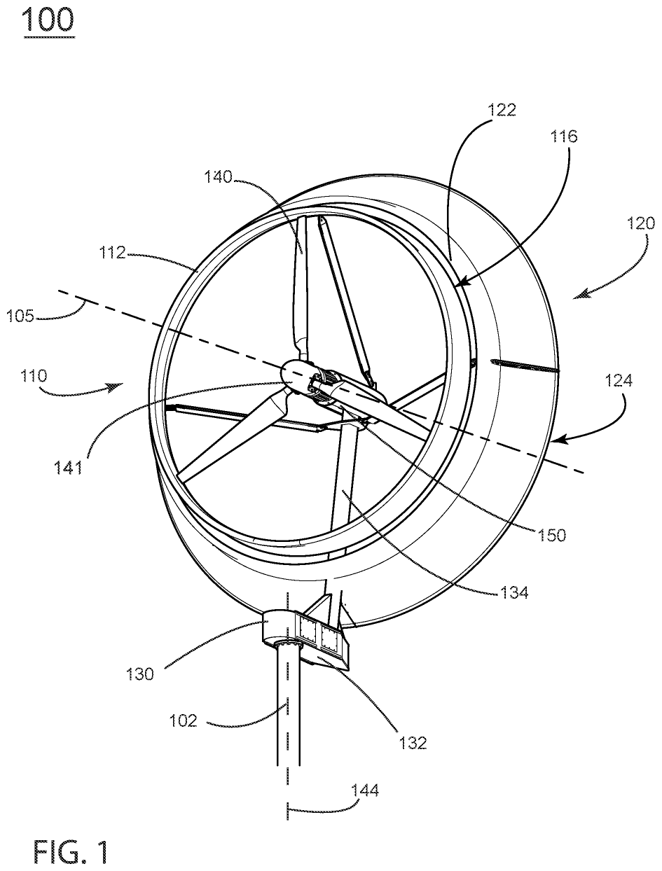

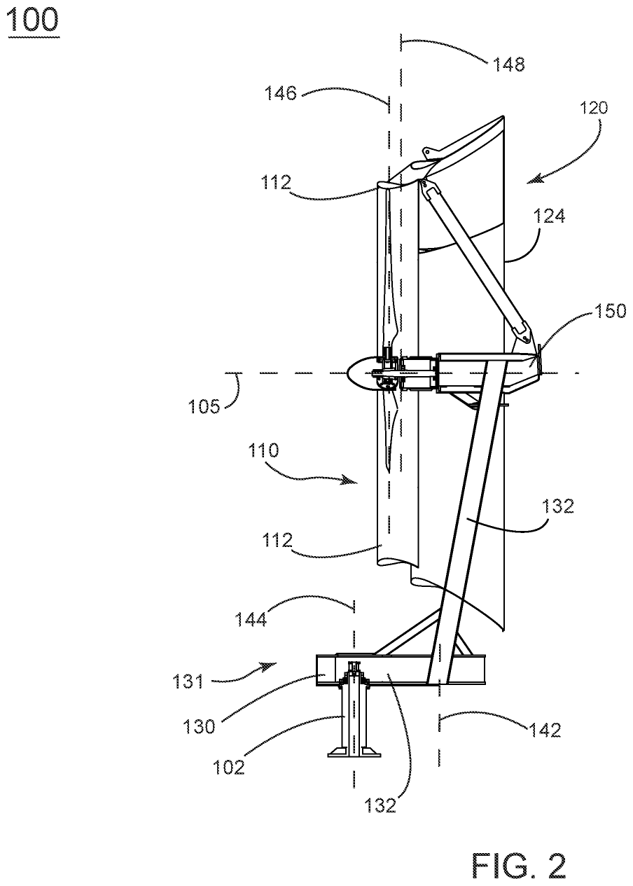

FIG. 1 and FIG. 2 show a fluid-turbine system 100 with a yaw axis 144 and yaw components in a yaw housing 130. A yaw system includes a resilient coupling between the drive motor and the pinion gear.

FIG. 1 shows an example turbine-shroud assembly 110 in the form of an annular duct that includes a leading-edge section 112 (also known as the inlet end). In certain embodiments, the leading edge 112 is substantially annular, providing a relatively narrow gap between the rotor-blade tips of rotor assembly 140 and the interior surface of the leading edge 112. In some embodiments, a secondary shroud assembly 120 or duct includes a substantially annular duct with leading edges 122 and a trailing edge 124 that is in fluid communication with the trailing edge 116 of the turbine-shroud assembly 110. The shroud assemblies 110, 120 are coaxial with the rotor assembly 140, rotor hub 141 and nacelle body 150 on a central axis 105. The rotor assembly 140 and shroud assemblies 110, 120 are supported by a tower structure 102 that has a central axis that is also referred to as a yaw axis 144. A horizontal support structure 132 extends from the yaw axis 144 to a vertical support structure 134 that extends from the horizontal support structure 132 to the nacelle 150.

In FIG. 2, the example shrouded turbine may be engaged with the support structure near the turbine's center of gravity while pivoting on the support structure on an axis that is offset from the center of pressure. The center of pressure generally defines the point on the turbine where the total sum of the pressure field causes a force and no moment-force about that point. The center of pressure of a shrouded turbine is typically near the downwind portion of the rotor plane.

Locations of the center of gravity 142, the yaw axis 144, the rotor plane 146 and the center of pressure 148 are illustrated with broken lines. The center of pressure 148 may be positioned downstream of the rotor plane 146. With the center of pressure 148 and the center of gravity 142 offset from the yaw axis 144, off-axis gusts tend to cause rotation about the yaw axis 144.

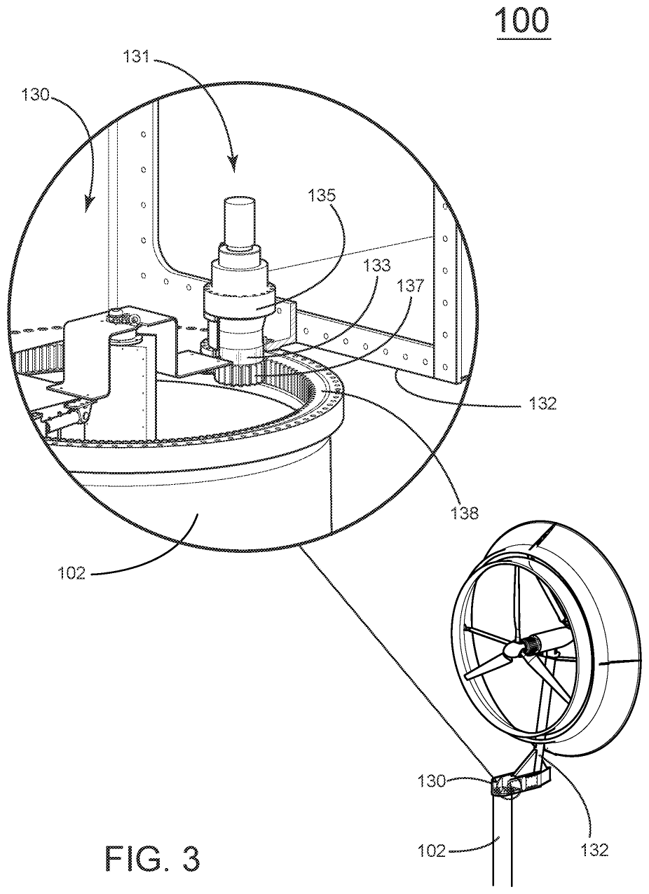

FIG. 3 shows a yaw system 131 that may be located in the tower 102 of the shrouded turbine 100 and has at least one motor-gear stack 135. The motor-gear stack 135 may be engaged with the shrouded-turbine pivoting structure 130 and may be rotationally engaged with the tower 102 about the yaw axis 144. The turbine pivoting structure 130 is further engaged with the horizontal support structure 132. The motor-gear stack 135, otherwise referred to as a transmission, may have a set of reduction gears that culminate at a drive shaft that is engaged with a resilient coupling 133, which is in turn engaged with pinion gear 137. The pinion gear 137 may be engaged with a ring gear 138 that is affixed to the tower 102.

The resilient coupling 133 may be any of a number of couplings that are designed to transfer torque and rotation from one shaft to another through a flexible or viscous medium including viscous coupling, a beam or helical coupling, a Geislinger coupling, or the like. Transferring torque and rotation through such a medium provides a damping means integrated into the yaw system. Damping rotational movement between the pinion gear 137 and the motor-gear stack 135 provides a means of decoupling coupled oscillations. Lateral oscillations caused by yaw error or off-axis gusts can couple with fore-aft oscillations. Lateral oscillations result in rotation of the turbine pivoting structure 130 and hence the motor-gear stack 135. By damping the lateral oscillations, the dynamic amplification between lateral and fore-aft oscillations is decoupled.

The systems and methods described herein are exemplary and not limited to the specific descriptions. Various modifications, enhancements and or variations of the disclosed embodiments are expressly encompassed herein. Since many changes could be made in the above construction and many widely different embodiments of this disclosure could be made without departing from the scope thereof, it is intended that all matter contained in the drawings and specification shall be interpreted as illustrative rather than limiting.

What is claimed is:

1. A fluid turbine comprising:
a rotor assembly; and
a nacelle assembly mechanically coupled with and rotationally engaged with said rotor assembly; and
a center of pressure residing downwind of said rotor assembly; and
a yaw assembly residing upwind of said center of pressure; and
said yaw assembly comprising a motor rotationally engaged with a drive shaft;
said drive shaft engaged with a resilient coupling;
said resilient coupling engaged with a pinion gear; and
said pinion gear movably engaged with a ring gear; and
said ring gear fixedly engaged with a tower assembly; wherein
vibrations are mitigated between said drive shaft and said pinion gear.

2. The fluid turbine of claim 1 further comprising:
a ringed airfoil in fluid communication with and surrounding said rotor assembly;
wherein
vibrations caused by off-axis gusts impacting said ringed airfoil are prevented from transferring between said drive shaft and said pinion gear.
